(19) United States
(12) Patent Application Publication
(10) Pub. No.: US 2004/0194553 A1
(43) Pub. Date: Oct. 7, 2004

(54) Device for determining the mass of flowing, foaming flow of liquid

(76) Inventor: Peter Kaever, Oelde (DE)

Correspondence Address: Smith & Amundsen, Suite 302, 440 Science Drive, Madison, WI, 53711, US

(21) Appl. No.: 10/467,208

(22) PCT Filed: Feb. 1, 2002
(86) PCT No.: PCT/EP02/01030

(30) Foreign Application Priority Data
Feb. 9, 2001 (DE) 10105927.2

(51) Int. Cl. G01F 1/00

(52) U.S. Cl. 73/861

(57) ABSTRACT

The invention relates to a method and a device for measuring flow of liquid based on a contact resistance measurement working inside the flow, containing a high degree of precision and robustness and characterized by a low cost price, simple subsequent assembly and easy cleaning. According to the invention, the liquid is vertically scanned e.g. by means of segmented electrodes or optical systems having vertical resolution, only one section of the vertical segments is scanned for effective use of the measuring device. The vertical segments which are to be scanned are derived from the post values of the scanning and from a reference profile which contains, for example the number of phases in the flow of liquid.

The object of the invention concerns a method for determination of an actual profile of phases of a flowing, foaming fluid stream layered one on the other, as well as a method and apparatus for determination of mass flow rate of a flowing, foaming fluid stream, especially a milk stream.

With increasing mechanization of dairy cattle management, there is increased interest in the determination of the individual amounts of milk of an animal and the amount of milk produced by a herd. Improved herd management is possible based on knowledge of the produced amounts of milk during individual milking processes and over specific periods. Individual determinations of the amount of milk produced by an animal during each milking process is therefore of interest. Precise weighing of the milk, however, is technically very demanding and difficult to implement in multiposition milking facilities.

Various concepts to determine the weight of the produced milk have therefore been developed. Determination of the weight of the produced milk by volume measurement is of particular importance. The instruments provided for this purpose have a measurement chamber in which either the weight of the contents is determined by means of a tipper or the volume is determined by means of a float or feeler electrodes. Instruments in which subdivision of the milk stream into small batches, whose volume or weight is determined, keep the inflow to the measurement chamber continuously open and a valve controls only the emptying.

Devices are also known with which the weight of milk can be determined in free-flow. These devices use ultrasound or infrared sensors and sharply constrict the cross section of the line and/or segment the fluid stream repeatedly. The problem of proportional separation of a partial stream with high precision arises here. Measurement instruments available thus far based on conductivity measurements have limited accuracy. There are also instruments that determine the fluid flow by binary evaluation of the sensor signal. The accuracy of instruments that operate according to the second method depends strongly on external parameters, like mounting, dynamics of the fluid stream, pressure and other parameters.

Instruments that operate according to the first method have the drawback that the fluid stream, in the first place, is not continuously measured and, in the second place, thorough cleaning of the individual components is necessary because of the more complex design.

In instruments that operate in a stream and whose line cross section is constricted or in which the fluid stream is repeatedly segmented, an increased vulnerability to contamination and poor cleaning possibilities result. The flow meter described, for example, in U.S. Pat. No. 5,083,459 does carry out a contact resistance measurement, but operates with a measurement chamber in which the fluid backs up, so that cleaning of the instrument is demanding.

Instruments with binary evaluation of the fluid stream are beset with inaccuracies related to the principle. The strong dependence on installation parameters, like vacuum level, is another drawback during adjustment on location. When alternative, demanding physical methods based on Coriolis force or magnetic resonance are used, high costs are incurred.

One problem in determining the weight of milk is that milk is a strongly foaming fluid so that a relatively high measurement uncertainty exists relative to the weight of the foaming milk. This problem is known and was described in EP 0 315 201 A2.

To solve this problem, it is proposed according to EP 0 315 201 A2 that the entire profile of the foaming liquid be determined. It is considered here that the specific density of the liquid/air mixture changes as a function of height. To measure the specific density of the foaming liquid at different height levels, a reference measured value is determined on a reference measurement path containing essentially degassed liquid. Depending on whether a value measured in air is larger or smaller than the reference measured value obtained in this reference measurement path, a ratio is formed for each height level, corresponding to the ratio of the reference value and the measured value at this height level and the inverse of the ratio is determined, respectively. A corrected ratio according to a stipulated calibration can optionally be formed, which equals 1 for degassed liquids and essentially equals zero for air. Each ratio is multiplied by the value for the specific density of the degassed liquid. The result of this multiplication gives the specific density of the foaming liquid. To determine the weight of a foaming liquid, the volumes are determined and these volumes multiplied by the specific density of the foaming liquid.

Determination of the measured values is carried out according to EP 0 315 201 A2 by means of a measurement device having a vessel on whose inside several individual electrodes electrically insulated from each other are arranged at equal height spacings one above the other. A counterelectrode is arranged opposite the electrodes. An ac voltage is applied to the counterelectrode. The measured value to determine the specific density of the foaming milk is carried out for each electrode from a corresponding voltage drop that depends on the medium situated between the electrode and the counterelectrode.

It is also known from EP 0 315 201 A2 that the light transmittance at specific height levels can also be used as the measured value.

A problem in the procedure known from EP 0 315 201 A2 and its apparatus is that during a determination of specific density by locally resolving measurement probes, a large number of measured values must be recorded to obtain the height of the liquid. This necessity is intensified in milk streams that vary sharply with time, so that the method described there is beset with drawbacks at high flow rates. Another drawback is the circumstance that the same evaluation scheme is used for essentially degassed liquid and for foam, which leads to overevaluation of the foam fraction. This again can only be compensated for by complicated calculation procedures that cause deterioration in the clarity of the method and significantly increase the numerical demands.

With this as a point of departure, the underlying objective of the present invention is to provide a method and apparatus that permits determination of an actual profile of phases layered one on the other and a mass flow rate of a flowing, foaming fluid stream, especially a milk stream, with high reliability even at high flow rates.

This objective is achieved according to the invention by a method for determination of the actual profile of phases of a mass stream layered one above the other of a flowing, foaming fluid stream with the features of claim 1, by a method for determination of a mass flow rate of a flowing, foaming fluid stream, especially a milk stream, with the features of claim 2 and by a device with the features of claim 17. Other advantageous embodiments of the method and the device are the object of the dependent claims.

According to the method of the invention for determination of the actual profile of phases layered one above the other in a flowing, foaming fluid, especially a milk stream, it is proposed that determination of the actual profile Iₜₖ and the corresponding height level Hⁱₜₖ of the layered phases P^{j}ₜₖ of the foaming fluid stream be done at each time tₖ with k=0 . . . n, in which the phase boundaries are determined. To determine this actual profile, information from past scanning times k−1, k−2, . . . is used in the method according to the invention. Calculations of derived quantities through which the fluid can be characterized at any scanning time tₖ therefore do not require scanning of all the height levels Hⁱₜₖ but can operate with a subset that reflects the situation, in particular, at the phase boundaries. Sufficient height levels are preferably scanned here so that coordination of each height level Hⁱ to a phase P^{j} of the fluid stream is possible.

According to another inventive idea, a method for determination of mass flow rate of a flowing, foaming fluid, especially a milk stream, is proposed, in which at each scanning time tₖ an actual profile Iₜₖ and the corresponding height level H^{j}ₜₖ of the layered phases P^{j}ₜₖ of the foamed fluid stream are determined. Determination of an actual profile Iₜₖ₊₁ corresponding to a later time tₖ₊₁ is done in at least one region of the height level Hⁱₜₖ that includes a phase boundary PG^{j}ₜₖ of two adjacent phases P^{j}ₜₖ and P^{j+1}ₜₖ, of at least one preceding scanning time tₖ₋ₘ. The densities ρ^{j}, height segments hⁱ, widths bⁱ of the fluid stream and velocities vⁱ corresponding to the different phases P^{j} are determined, in which the following applies for the mass flow rate \dot{m}:

\dot{m}=Σv^{j}ρ^{j}hⁱbⁱ

\dot{m} is the time value of the mass flow rate in which summation extends over all height segments hⁱ and widths bⁱ of the fluid stream.

Superscript j in the summation is obtained by coordinating the height levels to the phases P^{j}.

The mass throughput and total weight of a flowing, foaming fluid stream can be determined with the method according to the invention with relatively high accuracy. Owing to the fact that it is checked whether a change in height level of the phase transitions of the current measurement occurs relative to the corresponding height levels of the preceding phase transitions, measurement is limited to the features that characterize the fluid stream so that the measurement and evaluation expense is substantially reduced.

According to an advantageous modification of the method it is proposed that the densities (ρ^{j}) of the different phases P^{j} be determined according to a reference model of a foaming fluid stream. The reference model can contain for the density ρ^{k} of each phase P^{k} information on the relation with density of the degassed fluid or the densities ρ^{j} of other phases P^{j}, k≠j. For example, the density ρ^{k} of individual phases P^{k} can be derived by ratio values or calculations of the reference model from the density ρ^{j} of other phases P^{j}, which are again obtained by direct or indirect measurement, parameterization on location or laboratory measurement.

However, the density ρ^{k} of phase P^{k} can also be obtained by direct or indirect measurement, parameterization on location or laboratory measurement. Measurement of the density ρ^{k} of a phase P^{k} can then occur by measurement or parameterization of individual or several height levels Hⁱ.

The density ρ^{e} of the degassed fluid can be considered as an additional phase for determination of the density ρ^{k}, which is again obtained by direct or indirect measurement or parameterization on location or laboratory measurement. Measurement on location can then occur at a location other than the location intended for determination of the phase boundaries.

At least one reference profile R of the phases PR^{j} of a foamed reference fluid lying at different height levels H^{j} is prepared, in which the reference profile R contains the specific density ρ^{j} or a characteristic K^{j} proportional to the specific density ρ^{j} for the individual phases PR^{j} and/or phase transitions PGR^{j} and the actual profile Iₜₖ is compared with the reference profile R to determine the specific density ρ^{j}ₜₖ of the corresponding volumes V^{j}ₜₖ and phase transitions PG^{j}ₜₖ. Determination of the reference profile is preferably carried out by a laboratory technique so that accurate data with reference to phase transitions, specific density of the individual phases can be determined. By comparing the actual profile with the reference profile, determination of the essential quantities that are necessary for determination of the weight of the flowing, foaming fluid stream can be achieved in a simplified fashion.

According to another advantageous embodiment of the method, it is proposed that the velocity vⁱ of the different phases P^{j} be determined by measurement and/or from a reference model of the foaming fluid stream. The velocities v^{j} are preferably determined here from the thicknesses d^{j} of the phases P^{j}. The reference model contains ratio values or calculation procedures for the velocities v^{j} of individual or several phases P^{j} with each other. The velocity of individual or all phases can be determined by direct or indirect measurement.

The velocity v^{j} can be determined from the thickness d^{j} of the phases P^{j} according to the law of flow. The thickness of the phase layer is scanned at at least two locations separated from each other and the signals corresponding to the locations are correlated with each other. By correlation, the time displacement Δt^{j} of the signals of at least two locations is obtained. From the known path difference Δs^{j} between the measurement sites, the velocity v^{j} of the phase P^{j} can be determined according to

v^{j}=Δs^{j}/Δt^{j}.

A process is preferred in which determination of the actual profile Iₖ and the corresponding height levels H^{j}ₜₖ of the layered phases P^{j}ₜₖ of the foamed fluid stream initially occurs at a time tₖ, and in which the phase boundaries are sought. From the data of the actual profile Iₜₖ, determination of the specific density ρ^{j}ₜₖ of the corresponding volumes V^{j}ₜₖ as well as the corresponding phase transitions PG^{j}ₜₖ at the corresponding height levels H^{j}ₜₖ is performed. At a later time tₖ₊₁ an additional determination of the actual profile Iₜₖ₊₁ is carried out in the height range of the preceding phase transitions PGₜₖ₋₁. It is then checked whether a change in height levels H^{j}ₜₖ of the phase transitions PG^{j}ₜₖ is present relative to the corresponding height levels H^{j}ₜₖ₋ₘ of the preceding phase transitions PG^{j}ₜₖ₋ₘ. If the check shows that a change in height levels H¹ₜₖ of the phase transitions PG^{j}ₜₖ of the last measurement lies within a tolerance field, it is assumed that the profile of the layered phases is unchanged relative to the preceding measurement.

If the check shows that the change in height levels Hₜₖ of the phase transitions PGₜₖ of the actual measurement lies outside the tolerance field, the actual profile, now already known in sections, is complemented via the additional measurement and the specific density, the corresponding volumes and the phase transitions of the new actual profile are determined. By this selective measurement and updating of the entire actual profile, only updating of the actual profile is required, which sharply reduces the implementation expense during measurement and evaluation.

According to another advantageous embodiment of the method, it is proposed that determination of the actual profile and/or checking of a possible change in height levels of the phase transitions occur based on contact resistance measurement. The contact resistance measurement yields time-resolved contact resistance signals in the free fluid stream. In this context free means that the measurement in the fluid stream occurs without backup of the fluid. Neither chambers nor other flow-inhibiting devices are therefore required, in other words, the measurement method is an actual fluid flow measurement that exhibits low flow resistance and does not require an indirect approach via a pressure measurement.

The contact resistance measurement advantageously is done between at least two parallel-spaced electrodes situated partly in the free fluid stream, especially electrical conductors. The contact resistance signal can be a one-dimensional quantity, as is obvious in the case of two conductors. However, it can also be a multidimensional quantity, if several conductors are used and the contact resistances are determined between the individual conductors. This advantageous embodiment of the method has the result that particularly high measurement accuracy is achieved. With this procedure high robustness relative to the effect of other parameters is achieved. The use of electrical conductors, for example, leads to a compact design and permits simple cleaning and adaptation to existing installations. The method according to the invention therefore permits economical implementation of the method and entails a low-maintenance work method.

According to another advantageous embodiment, it is proposed that the fluid stream be guided over an edge or slope and the contact resistance signal determined between at least two parallel, spaced conductors on the edge or slope. Depending on the thickness of the fluid stream, the conductors are flowed around by the fluid stream with different intensity so that a smaller resistance between conductors is obtained for thicker fluid streams. In the simplest variant, a proportional ratio between fluid stream and resistance is obtained by appropriate geometry of the conductors. As an alternative, measurement of the fluid stream is also possible for other geometries, but requires an appropriate, optionally nonlinear, conversion of the resistance signal to the actual fluid stream.

According to another advantageous embodiment of the method, the fluid stream is guided at least in one section through a downpipe and the contact resistance signal is determined there between at least two parallel, spaced conductors. The advantage of this variant is that, in the first place, measurement errors because of time-variable viscosity of the fluid are less critical and, on the other hand, so are fluctuations in velocity of the fluid stream. Precise determination of the thickness of the fluid stream can therefore be achieved directly from a simple cross-sectional measurement of the fluid stream, as is accomplished by at least two electrical conductors.

The measurement preferably occurs by means of segmented electrodes. As an alternative or in addition to electrodes, determination of the actual profile can be based on optical measurement. The optical measurements can then occur by optical elements with locally integrated evaluation. A lens system is preferably involved here. Measurement preferably occurs by using integrated devices with optically resolving measurement. These are preferably CCD elements.

The conductance value of the fluid is preferably measured in time-resolved fashion. Time fluctuations of the contact resistance signal based on fluctuations of the conductivity value of the fluid can be established in this way, as are produced in the case of milk because of a time-varying composition of the milk within one milking session, and taken into consideration in the determination of the fluid stream from the contact resistance signal. Advantageously, both the conductivity value of the fluid in the purely liquid phase and also the conductivity value of the fluid in the liquid-gas phase are measured.

The contact resistance measurement and/or conductivity measurement of the fluid occurs by means of an alternating current. This has the advantage that electrolytic deposits on the measurement electrodes that lead to an overvoltage, and therefore incorrect measurement results, are avoided.

For an even further quantitative improvement in determination of the weight of a flowing, foaming fluid, it is proposed that the conformity of the fluid stream be initially produced by means of a conformity device. The task of the conformity device essentially consists of calming the fluid stream. The conformity device can also assume additional tasks. For example, it can be used to reduce the number of phases layered one on the other so that the field of the high levels and therefore the measurement processes being conducted is reduced without a reduction in accuracy of determination of the weight of the flowing, foaming fluid stream.

According to another inventive idea, a device for determination of the weight of the flowing, foaming fluid stream, especially a milk stream, is proposed that has a measurement device to determine an actual profile and the corresponding height levels of the layered phases of the foam fluid stream at stipulated times. The device also has a storage unit in which the data significant for the actual profile are stored. For evaluation of the quantities relevant for the actual profile, especially the specific density, the corresponding volumes and the phase transitions, an evaluation unit is provided. A check whether a change in height levels of the phase transitions of the current measurement relative to the corresponding height levels of the previously determined phase transitions was present is done by means of a comparison unit. In addition, the device has a control unit electrically connected to the comparison unit and measurement device, in which the control unit operates the measurement device at stipulated time intervals as a function of the result of the comparison, so that measurement occurs at least in the height range of the previously determined phase transitions. A special device or correlation method is proposed for determination of the flow rate of the fluid stream.

This device according to the invention for determination of the velocities in a flowing, foaming fluid stream, especially a milk stream, has the advantage that determination of the velocity is achieved with relatively simple means and with high accuracy.

According to an advantageous embodiment of the device, it is proposed that a conformity device for the fluid stream be provided upstream of the measurement device. Equalization of the fluid stream is achieved by the conformity device so that the boundary conditions of the measurement are simplified and the cost reduced.

The measurement device is formed according to one embodiment of the method by at least one resistance measurement device having at least two spaced electrical conductors, the resistance measuring device determining the time-resolved contact resistance between the spaced electrical conductors, which are preferably in the free fluid channel so that both are always partially flowed around by the fluid stream.

According to another advantageous embodiment of the device, the conductors are spaced parallel to each other on one edge or are arranged on slopes. It is unimportant here whether they are perpendicular, horizontal, oblique or lateral relative to the fluid stream but it is decisive that they intersect the surface of the fluid stream so that the deviations in height of the fluid stream that are the gauge of the thickness of the fluid stream can be recorded by the resistance signal.

According to a preferred embodiment of the device, the conductors are arranged spaced and parallel from each other in a downpipe. This arrangement has the advantage that the effect of time-variable flow rate of the fluid, conductivity and the effect of time-varying viscosity are minimized.

To determine the flow rate of the fluid stream, in addition to direct measurement or the use of a subordinate downpipe, it is proposed that the device have two measurement devices arranged one behind the other in the direction of flow of the fluid stream and connected to a correlation unit. By correlation of the data determined from the measurement devices and knowing the spacing between the measurement devices, determination of the flow rate can be achieved by correlation of the measurement results.

Additional details and advantages of the invention are explained with reference to a preferred practical example. In the drawings:

FIG. 1 schematically depicts in cross section the phases of a reference fluid layered one on the other,

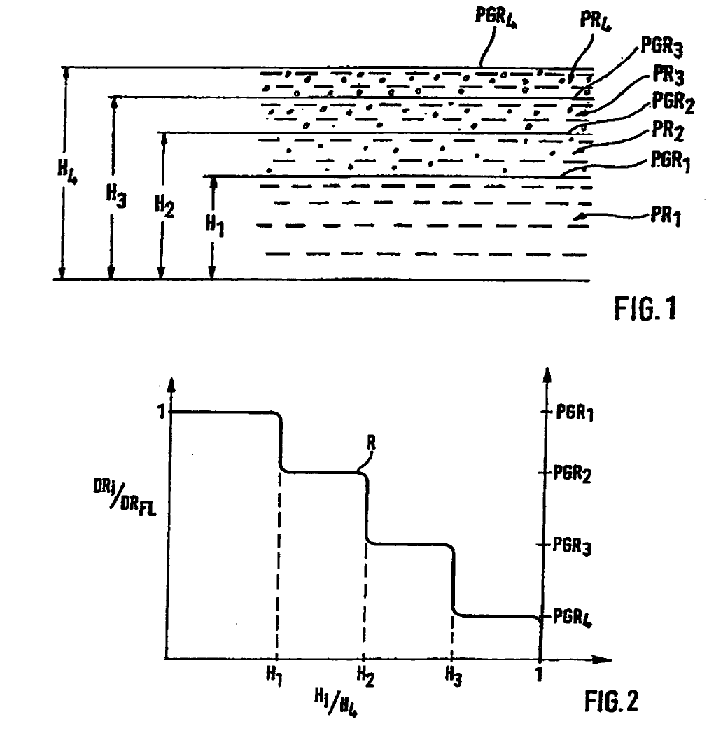

FIG. 2 schematically depicts a diagram of specific density versus height level of the reference fluid,

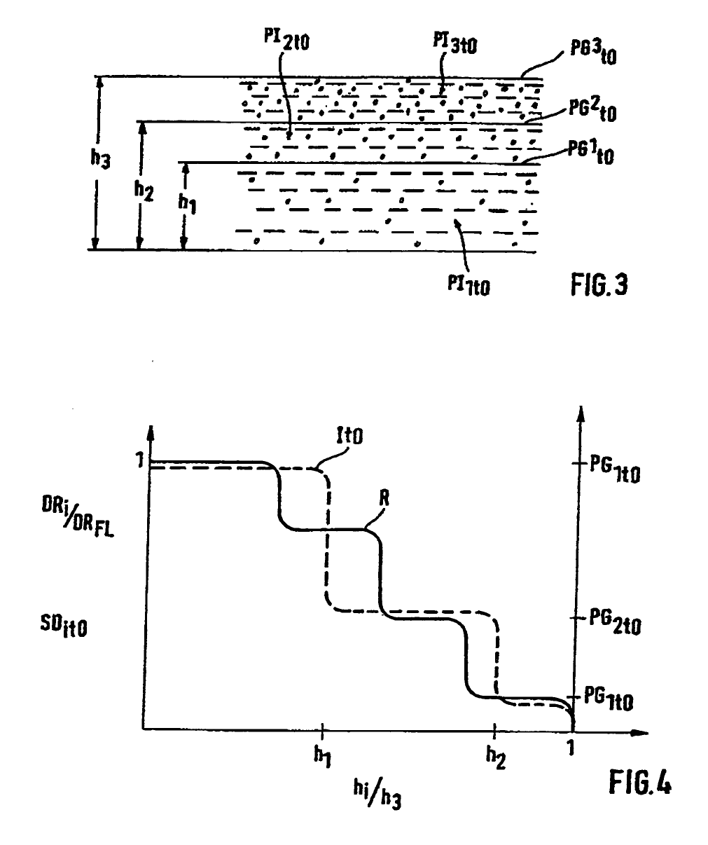

FIG. 3 shows an instantaneous recording of the fluid stream in cross section,

FIG. 4 schematically depicts a diagram of the specific density of the functional height level of the fluid,

FIG. 5 schematically depicts a first embodiment of the device for measurement of a fluid stream in cross section,

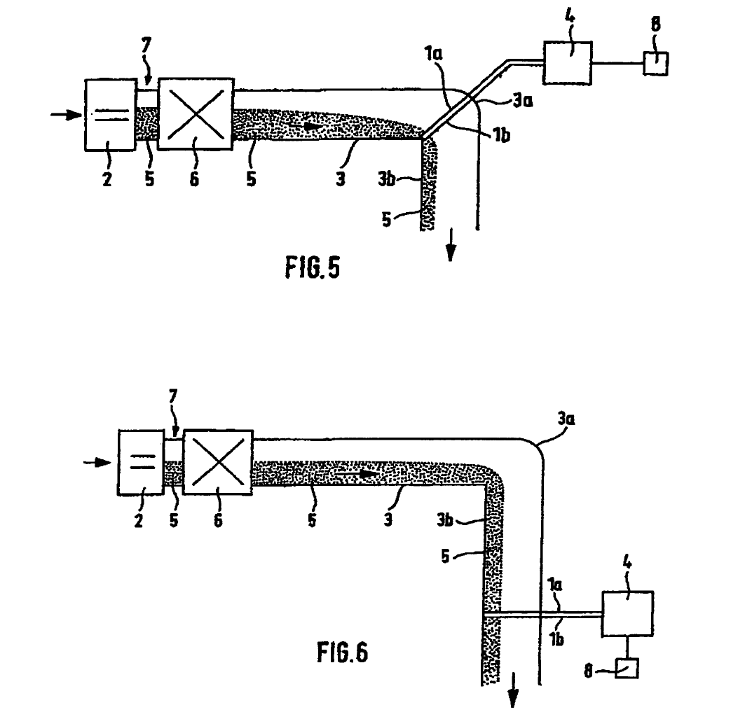

FIG. 6 shows an additional practical example of a device in cross section,

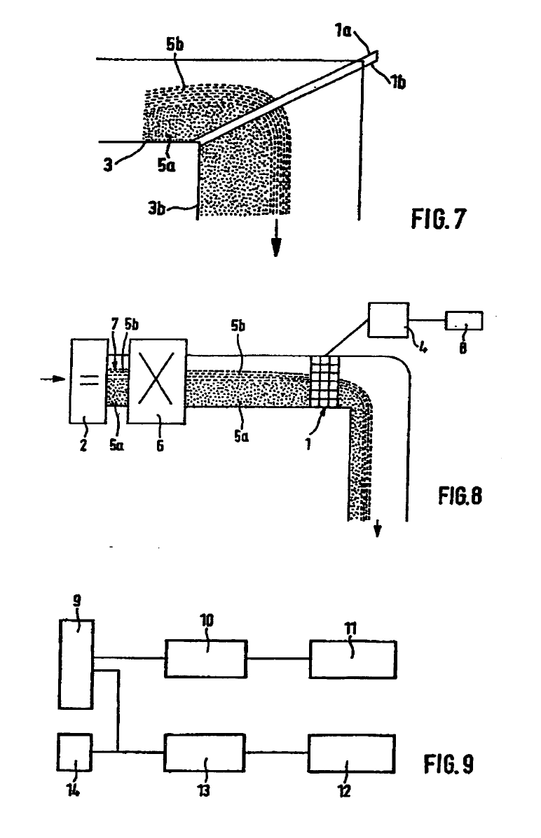

FIG. 7 shows a cutout of the device according to FIG. 5 for two fluid streams of different size,

FIG. 8 shows another practical example of the device in cross section and

FIG. 9 shows still another practical example of the device.

FIG. 1 schematically depicts the structure of a reference fluid. The reference fluid has a multilayered structure. It has several layered phases PR⁴. Between adjacent phases there is a phase boundary PGR¹ to PGR⁴. Phase boundary PGR⁴ is a phase boundary between a foam phase PR⁴ and air. The phase boundaries lie at different height levels H¹ to H⁴. In the depicted practical example of the reference fluid, phase PR¹ is a liquid, whereas PR², PR³ and PR⁴ are foams having different consistency.

FIG. 2 schematically depicts a reference profile R in a diagram. The height levels H¹ are normalized to the largest possible height level H⁴ on the abscissa. The specific density ρ¹ referred to the specific density of the liquid of the fluid is normalized on the ordinate. Significant changes in specific density ρⱼ define the phase boundaries PGR^{j}.

FIG. 3 schematically depicts an instantaneous recording of a fluid stream, especially a flowing, foaming milk stream. The milk stream has three-layered phase PI¹ₛ₀, PI²ₛ₀ and PI³ₛ₀. The phase boundaries PG¹ₜ₀, PG²ₜ₀, and PG³ₜ₀ lie between the individual phase layers. These phase boundaries lie at the corresponding height levels H¹, H² and H³.

The actual profile Iₜ₀ is compared with the reference profile R to determine the specific density ρ^{j}ₜ₀ and the phase transitions PG^{j}ₜ₀. This comparison is shown in FIG. 4.

FIG. 5 shows in cross section an apparatus to determine a fluid stream 5. The flow direction of the fluid is indicated by arrows. The fluid is initially taken up by a conformity device 2. The task of the conformity device 2 is to calm the fluid stream 5 and optionally also to reduce the number of phases. This occurs, for example, by means of specially formed chambers, holes, slits, grates and/or separation devices, like U-tubes or the like. The fluid stream 5 is then passed through a fluid feed line 7 from the conformity device 2 to a measurement device 6 to determine the conductivity of the fluid. The measurement device 6 includes essentially a measurement cell, which contains two electrodes 1a, 1b, which are completely flowed around by the fluid stream 5 and measure the contact resistance of the fluid preferably by means of alternating current. By means of the geometric dimensions of the measurement cell and the measurement contact resistance signal, the conductivity of the fluid can be determined. The electrodes are preferably designed segmented. As an alternative or in addition to the electrodes, determination of the actual profile based on an optical measurement can also be performed. This optical measurement can then occur by means of optical elements with locally integrated evaluation. This is preferably a lens system. Measurement preferably occurs by using integrated devices with an optically resolving measurement. The devices are preferably CCD elements.

It is particularly advantageous to determine the conductivity in a time-resolved manner, since the composition of the fluid within a milking session can vary sharply, depending on the time of day and season, nutrition and health of the cows and other parameters.

The conductivity value measurement is independent of the actual thickness of the fluid stream 5. A fluid channel 3 is connected to the measurement device 6 for determination of the conductivity, which has a bend 3a so that the fluid stream 5 flows downward vertically in a downpipe 3b after an initially horizontal run, where it enters a connected vessel not shown in the figure. Two parallel, spaced electrodes 1a, 1b are arranged in the practical example according to FIG. 1 in bend 3a and can be wires, for example. The fluid stream 5 flows around the two electrodes 1a, 1b partially so that, depending on the thickness of the fluid stream 5, a more or less larger section of the two electrodes 1a, 1b is flowed around by the fluid. A thicker fluid stream 5 leads to a broader contact of the two electrodes 1a, 1b, resulting in a lower contact resistance between the two electrodes 1a, 1b. A resistance measurement device 4 measures the contact resistance between the two electrodes 1a, 1b in time-resolved fashion, i.e., continuously, and provides a gauge for the height of the fluid stream 5 along the axis of the two electrodes 1a, 1b. A microprocessor 8 is connected after the resistance measurement device 4, which permits determination of the amount of fluid from a time-resolved contact resistance signal and/or a time-resolved conductivity signal of the fluid. The bend 3a, as shown here, can have an angle of 90°. Other angles, especially less than 90°, however, are also possible, as is a rounding or slope instead of a bend 3a.

In this variant it is apparent that the fluid channel 3 is free, in particular, has no measurement chamber. The electrodes 1a, 1b can also be designed plate-like. It is advantageous if electrodes 1a, 1b are arranged parallel at a spacing, since then the contact resistance is used to determine the fluid stream 5. It is also advantageous to integrate the electrodes 1a, 1b in the wall of the fluid channel 3 so that no additional flow resistance occurs, cleaning of the fluid channel 3 is simplified and the vulnerability of device 6 the contamination is reduced. The fluid channel 3 itself can have any cross section but a rectangular cross section is preferred.

At least one of the electrodes is segmented when viewed essentially perpendicularly to the direction of flow. At time to a measurement is made from which the actual profile Iₜ₀ of the fluid stream is obtained. From this actual profile Iₜ₀ and the corresponding height levels Hⁱₜ₀, which correspond to the height position of the individual segments of the electrode, the layered phases P^{j}ₜ₀ that form the fluid stream 5 can be determined. With reference to the actual profile, the specific density ρ^{j}ₜ₀ and the phase transitions PG^{j}ₜ₀ of the actual profile Iₜ₀ as well as the height segments hⁱ and the widths b¹ of the fluid stream can be obtained.

After a stipulated time interval, redetermination of an actual profile Iₜ₁ in the height range of the preceding phase transitions PG^{j}ₜ₀ occurs. The new sections so determined for the actual profile Iₛ₁ are compared with the already known data of the actual profile Iₜ₀. If comparison shows that the change in phase transitions lies within a tolerance field, it is assumed that the fluid stream 5 has the same layer structure at time t₁ as at time tⱼ.

If the change lies outside of a tolerance field, the actual profile Iₜ₁ is fully determined, in which only the electrode sections that give more precise information concerning the phase boundaries are operated. A complete actual profile at time t₁ is obtained from this, from which the data necessary to determine the weight are then determined.

This process is conducted during the entire flow time of the fluid stream 5 in stipulated time intervals. By knowledge of the specific densities ρ^{j}ₜₖ, flow rate and flow time, the weight of the fluid stream 5 can be determined. For the mass stream m, the following applies:

\dot{m}=Σv^{j}ρ^{j}hⁱbⁱ

\dot{m} is the time value of the mass flow rate in which the summation extends over all height segments hⁱ and widths bⁱ of the fluid stream. Superscript j in the summation is obtained by coordinating the height levels to the phases P^{j}.

FIG. 6 shows another practical example of a device in cross section. In contrast to FIG. 5 the electrodes 1a, 1b are arranged in the section of the fluid channel 3 that runs vertically, i.e., in the downpipe 3b. This arrangement has the advantage that deviations in viscosity, as occur in the case of a time-variable composition of the milk within one milking session, do not adversely affect the measurement accuracy of the device. The vertical velocity of the fluid stream 5 is largely given by the falling height and is essentially independent of the viscosity.

FIG. 7 shows a cutout of the device according to FIG. 5 for two different states: in a thicker fluid stream 5a the surface is higher than in a thinner fluid stream 5b. It is apparent that for the thicker fluid stream 5a, the electrodes 1a, 1b are wetted and therefore contacted along their axis over a larger height of fluid.

FIG. 8 shows another practical example of a device in cross section. In this case the electrodes 1a, 1b are segmented electrodes, for example grates of wires or fields of point contacts between which the contact resistance are measured so that the fluid stream 5a in the pure liquid phase and also the fluid stream 5b in the liquid-gas phase can be determined. The milk stream 5a, 5b is resolved spatially by means of the segmented electrodes.

The present invention is particularly suited for measurement of a pulsating fluid stream 5 and operates in flows with a high degree of precision and robustness. It is characterized by low acquisition costs, simple retrofitting and simple cleaning.

FIG. 9 schematically depicts a device for determination of the weight of a flowing, foaming fluid stream, especially a milk stream. The device comprises a measurement device to determine an actual profile of the corresponding height levels of the layered phases of the foam fluid stream at stipulated times. The measurement device 9 is connected to a memory unit 10 in which the data significant for the actual profile are stored. The device is also provided with an evaluation unit 11 in which the actual profile is evaluated with respect to relevant quantities, especially with respect to specific density, corresponding volumes and the phase transitions of the actual profile. Checking occurs in a comparison unit 12 to determine if a change in height levels of the phase transitions above the corresponding height levels of the previously determined phase transitions occurred. The device also has a control unit 13 that is electrically connected to the comparison unit 12 and the measurement device 9, the control unit 13 operating the measurement device at stipulated time intervals as a function of the result of the comparison so that measurement occurs at least in the height range of the previously determined phase transitions. In addition, a device 14 for determination of the flow rate of the fluid stream is often provided, which is also connected to the control unit 13.

List of Reference Numbers:

1, 1a, 1b electrode

2 conformity device

3 fluid channel

3a bend in fluid channel 3

3b downpipe

4 resistance measurement device

fluid stream

5a fluid stream in pure liquid phase

5b fluid stream in liquid-gas phase

6 device for measurement of the conductivity of the fluid

7 fluid feed line

8 microprocessor

Abbreviations with Reference to the Fluid Phases:

P^{j}: phase j of the fluid

Iₜ: actual profile of the fluid phase of the time t

PG^{j}: phase boundary of phase j to phase j+1

H^{j}ₜ: height level of the boundary layer of phase j to phase j+1

ρ^{j}: density of phase j

ρ^{e}: density of the degassed fluid

V^{j}: velocity of phase j

d^{j}: layer thickness of phase j

Abbreviations with Reference to Measurement Sites:

hⁱ: height difference of measurement site i to measurement site i+1

bⁱ: width of the milk channel at measurement site i

Δsⁱ: distance between two measurement sites arranged in succession in the fluid stream in which both lie in the same phase j

1. Method for the determination of an actual profile of layered phases (P^{j}) of a flowing, foaming fluid stream (5), especially a milk stream, in which an actual profile (Iₜₖ) and the corresponding height levels (H^{j}ₜₖ) of the layered phases (P^{j}ₜₖ) of the foamed fluid stream (5) are determined at each scanning time (tₖ), the determination of an actual profile (Iₜₖ₊₁) corresponding to a later time (tₖ₊₁) occurring in at least one region of a height level (H^{j}ₜₖ₋ₘ) that includes at least one phase boundary (PG^{j}ₜₖ₋ₘ) of two adjacent phases (P^{j}ₜₖ₋ₘ; P^{j+1}ₜₖ₋ₘ) of at least one previous scanning time (tₖ₋ₘ).

2. Method for determination of a mass flow rate of a flowing, foaming fluid stream (5), especially a milk stream, having layered phases (P^{j}) in which, at each scanning time (tₖ), an actual profile (Iₜₖ) and the corresponding height levels (H^{j}ₜₖ) of the layered phases (P^{j}ₜₖ) of the foamed fluid stream (5) are determined, in which determination of an actual profile (Iₜₖ₊₁) corresponding to a later time (tₖ₊₁) is done in at least one region of height level (H^{j}ₜₖ₋ₘ) that includes at least one phase boundary (PG^{j}ₜₖ₋ₘ) of two adjacent phases (P^{j}ₜₖ₋ₘ; P^{j+1}ₜₖ₋ₘ) of at least one previous scanning time (tₖ₋ₘ) and the densities ρ^{j} height segments hⁱ, widths bⁱ and velocities v^{j} of the fluid stream corresponding to the different phases (P^{j}) are determined, in which the following applies for the mass flow rate \dot{m}:
\dot{m}=Σv^{j}ρ^{j}hⁱbⁱ.

3. Method according to claim 2 in which the densities (ρ^{k}) of the different phases (P^{j}) are determined according to a reference model of a foaming fluid stream.

4. Method according to claim 3 in which the reference model for density (ρ^{k}) of each phase (P^{k}) contains information on the relation between density (ρ^{k}) and density of the degassed fluid or densities (ρ^{j}) of other phase (P^{j} with k≠j).

5. Method according to claim 2 in which the densities (ρ^{j}) of the different phases (P^{j}) are determined by measurement.

6. Method according to one of the claims 2 to 5 in which the velocities (v^{j}) of the different phases (P^{j}) are determined by measurement and/or from a reference model of the flowing fluid stream.

7. Method according to claim 6 in which the velocities (v^{j}) are determined from the thicknesses (d^{j}) of the phases (P^{j}).

8. Method according to claim 7 in which determination of the thickness (d^{j}) of the phases (P^{j}) occurs at at least two locations spaced from each other and the time displacement (Δt^{j}) of the signals corresponding to the thicknesses (d^{j}) are used to determine the velocity (v^{j}) of the phase (P^{j}).

9. Method according to one of the claims 1 to 8 in which determination of the actual profile (Iₜₖ) and/or checking for a possible change in height levels (H^{j}ₜₖ) of the phase transitions (PG^{j}ₜₖ) and/or determination of one or more specific densities (ρ^{j}) is done based on contact resistance measurement.

10. Method according to claim 9 in which the contact resistance measurement occurs between at least two parallel-spaced electrical conductors (1a, 1b) lying partially in the free fluid stream (5).

11. Method according to claim 10 in which the fluid stream (5) is guided over an edge or slope and a contact resistance signal between the at least two parallel-spaced conductors (1a, 1b) is determined on the edge or the slope.

12. Method according to claim 9 or 10 in which the fluid stream (5) is passed through a downpipe (3b) at least in one section and the contact resistance signal is determined there between at least two parallel-spaced conductors (1a, 1b).

13. Method according to one of the claims 9 to 12 in which at least one conductor is designed segmented and individual segments and/or groups of segments are controllable.

14. Method according to one of the claims 1 to 8 in which determination of the actual profile (Itk) and/or checking for a possible change in height levels (H^{j}ₜₖ) of the phase boundary (PG^{j}ₜₖ) and/or determination of one or more specific densities (ρ^{j}) is carried out based on optical measurements.

15. Method according to claim 14 in which optical measurement is carried out by means of optical elements with locally integrated evaluation.

16. Method according to claim 14 in which the optical resolving measurement is carried out by means of integrated devices.

17. Device for determination of the weight of a flowing, foaming fluid stream (5), especially a milk stream, with
a measurement device (9) for determination of an actual profile (Iₜₖ) and the corresponding height levels (H^{j}ₜₖ) of the layered phases (P^{j}ₜₖ) of the foamed fluid stream (5) at stipulated scanning times (tₖ),
the memory unit (10) in which the data significant for the actual profile (Iₖ) are stored,
an evaluation unit (11) in which the actual profile (Iₖ) is evaluated with respect to relevant quantities, especially with respect to height segments (hⁱ), widths (bⁱ) of the fluid stream and velocities (v^{j}), specific density (ρ^{j}) and phase transitions (PG^{j}ₜₖ) of the actual profile (Iₜₖ),
a comparison unit (12) through which it is checked if a change occurred in height levels (H^{j}ₜₖ) of the phase transitions (PG^{j}ₜₖ) relative to the corresponding height levels (H^{j}ₜₖ₋ₘ) of the previously determined phase transitions (PG^{j}ₜₖ₋ₘ),
a control unit (13), which is electrically connected to the comparison unit (12) and the measurement device (9), in which the control unit (13) operates the measurement device (9) at stipulated time intervals as a function of the result of the comparison so that measurement occurs at least in the height range of the previously determined phase transitions (PG^{j}ₜₖ₋ₘ) and with a device (14) for determination of the flow rate of the fluid stream (5).

18. Device according to claim 17, characterized by the fact that a conformity device (2) for the fluid stream (5) is provided upstream of the measurement device (9).

19. Device according to claim 17 or 18, characterized by the fact that the measurement device (9) is formed by at least one resistance measurement device (4) having at least two parallel, spaced electrical conductors (1a, 1b) in which the electrical conductors (1a, 1b) are arranged in the free fluid channel (3) so that they are both always partially flowed around by the fluid stream (5).

20. Device according to claim 19, characterized by the fact that the conductors (1a, 1b) are arranged parallel and spaced from each other on one edge or a slope.

21. Device according to claim 19, characterized by the fact that the conductors (1a, 1b) are arranged at a spacing parallel to each other in a downpipe (3b).

22. Device according to one of the claims 17 to 21, characterized by the fact that it additionally contains a device (6) for the determination of the conductivity of the fluid and/or an optical density.

23. Device according to claim 17, characterized by the fact that the measurement device (9) has optical elements with a locally integrated evaluation.

24. Device according to claim 17, characterized by the fact that the measurement device (9) has optical elements with an optically resolving evaluation.

25. Device according to one of the claims 17 to 21, characterized by the fact that at least one conductor is designed segmented and individual segments and/or groups of segments are controllable.

26. Device according to one of the claims 17 to 25, characterized by the fact that it has two measurement devices (9) arranged in succession in the direction of flow of the fluid stream (5), which are connected to a correlation unit.
